(19) United States
(12) Patent Application Publication
(10) Pub. No.: US 2010/0280162 A1
(43) Pub. Date: Nov. 4, 2010

(54) DISPERSING AGENT

(76) Inventors: Elvira Stesikova, Ypsilanti, MI (US); Ronald Lee, Branchburg, NJ (US); Gregory Drewno, Riverview, MI (US); Jacob Wildeson, Chambersburg, PA (US)

Correspondence Address: HOWARD & HOWARD ATTORNEYS PLLC;BASF SE, 450 West Fourth Street, Royal Oak, MI, 48067, US

(21) Appl. No.: 12/771,362

(22) Filed: Apr. 30, 2010

Related U.S. Application Data
(60) Provisional application No. 61/174,154, filed on Apr. 30, 2009.

(51) Int. Cl. C08K 5/06; B41M 5/165; C09D 5/00

(52) U.S. Cl. 524/376; 106/311; 106/287.26

(57) ABSTRACT

A dispersing agent and a composition including a pigment and the dispersing agent are provided. The dispersing agent includes a branched alcohol alkoxylate having the following formula (I):

X(Y)ₘ(Z)ₙH (I)

In the formula (I), X is a C₆ to C₁₆ branched chain, Y represents a propyleneoxy group, butyleneoxy group, or combination thereof, Z represents an ethyleneoxy group, propyleneoxy group, butyleneoxy group, or combination thereof, subject to the proviso that the molar ratio of ethyleneoxy groups to propyleneoxy groups and/or butyleneoxy groups in (Z)ₙ is at least 2.9:1. Also in formula (I), m is on average from about 1.8 to about 5 and n is on average from about 8 to about 25. The dispersing agent is capable of attaining color development, freeze/thaw stability, and reduced water sensitivity similar to that achieved by widely-used APEOs.

### RELATED APPLICATIONS

The subject patent application claims priority to, and all the benefits of, U.S. Provisional Patent Application Ser. No. 61/174,154, filed on Apr. 30, 2009. The entirety of this provisional patent application is expressly incorporated herein by reference.

### BACKGROUND OF THE INVENTION

1. Field of the Invention

The subject invention generally relates to a dispersing agent and a coating composition including the dispersing agent. More specifically, the subject invention relates to a dispersing agent that can be added to a coating composition to wet pigments for excellent color development while providing the coating composition with excellent freeze/thaw stability without the need for alkylphenol chemistry, with the dispersing agent having a minimized VOC content.

2. Description of the Prior Art

Coating compositions are well known in the art for use in various applications, especially in the construction industry for decorative and protective uses. The coating compositions are typically prepared by coloring or tinting a base composition at a point of purchase through addition of a pigment dispersion including organic and/or inorganic pigments or through in-plant tinting at point of manufacture. The base composition includes a polymeric base, such as acrylic latex, and may be water-borne or solvent-borne. Pigment dispersions are formulated for both water-borne and solvent-borne base compositions to be easily miscible and stable in the base composition.

A relative tint strength of the pigment dispersion, which is one aspect of color development, is one of the most important properties of the pigment dispersion. Tint strength is a function of a degree of dispersion of the pigment in the pigment dispersion and is a measure of color intensity. Specifically, more complete dispersion of the pigment within the pigment dispersion correlates to more intense color in the pigment dispersion and the resulting coating composition. As a result of more complete dispersion of the pigment, the pigment dispersion may be formulated with a lower pigment concentration to achieve desired tint strength as compared to pigment concentrations that are required when poorer dispersion of the pigment is achieved.

The pigment dispersions and/or coating compositions are formulated with additional additives in order to promote or hinder certain properties. For example, dispersing agents have been used as a key component to aid pigment dispersion in coating compositions, stabilize dispersed particles, and provide acceptable color development. Conventional dispersing additives, such as alkyl phenol ethoxylates (APEO), are used due to their effectiveness in dispersing particles. One example of a widely-used APEO is Triton® CF-10 commercially available from Dow Chemical of Midland, Mich. However, APEOs are under EPA regulatory scrutiny due to claimed aquatic toxicity and suspected estrogen-mimicking nature. Such concerns have led to a voluntary ban on the use of APEOs within the European Union as well as a ban on the use of APEOs for certain end segments within Canada. Therefore, many companies are re-formulating coating compositions or developing new coating compositions to eliminate the APEO dispersing additives. In addition, the presence of residual benzyl chloride in the Triton CF-10 has come under scrutiny with some regulatory authorities, such as Health Canada, which may lead to further restrictions in use. However, APEOs are not easy to replace because of their effectiveness in wetting and dispersing properties. The structure of APEO surfactants provides excellent stabilization and contributes to robust, multifunctional properties including wetting, dispersing, and emulsification. In addition, APEO surfactants have an excellent cost-to-performance ratio which makes them very attractive.

Alcohol alkoxylates are one class of additives that are known for use in coating compositions. Alcohol alkoxylates cover a broad spectrum of additives that perform various functions, such as defoaming, wetting, dispersing, coalescing and acting as a surfactant. An example of one type of alcohol alkoxylate has the following formula:

X(Y)ₙH

wherein X is selected from the group of linear carbon chains, branched carbon chains, aromatic rings, and combinations thereof, Y is selected from the group of ethyleneoxy groups, 1,2-propyleneoxy groups, 1,2-butyleneoxy groups, and combinations thereof, and n is from to 1 to 75. Such alcohol alkoxylates, when included in the coating compositions, are present for any of the functions as described above.

Alcohol alkoxylates based upon Guerbet C-10 alcohols have been developed and are currently sold under the tradename Lutensol® by BASF Corporation of Florham Park, N.J. for use as surfactants including for use as dispersing agents. Such alcohol alkoxylates contain both ethyleneoxy and propyleneoxy groups. While it has been suggested in the art to produce alcohol alkoxylates with various combinations and amounts of different alkylene oxides, there have been no recognized alternative dispersing agents for attaining color development and freeze/thaw stability that is on par with alkylphenol-based dispersing agents such as Triton® CF-10, and that have sufficiently low VOC content.

Due to the strong demand to develop viable alternatives to replace APEOs in pigment dispersions and coating compositions without sacrificing physical properties, and while minimizing VOC content of such replacements, there is an opportunity to provide a dispersing agent, and a composition including the dispersing agent, that further improves upon the existing replacements for APEOs and that is capable of attaining color development, freeze/thaw stability, and reduced water sensitivity similar to or better than that achieved by widely-used APEOs such as Triton® CF-10, and that has minimal VOC content.

### SUMMARY OF THE INVENTION AND ADVANTAGES

The subject invention provides a dispersing agent, a method of forming the dispersing agent, and a composition including the dispersing agent. The dispersing agent includes a branched alcohol alkoxylate having the following formula (I):

X(Y)ₘ(Z)ₙH (I)

In the formula (I), X is a C₆ to C₁₆ branched chain, Y represents a propyleneoxy group, butyleneoxy group, or combination thereof, Z represents an ethyleneoxy group, propyleneoxy group, butyleneoxy group, or combination thereof, with the proviso that the molar ratio of ethyleneoxy groups to propyleneoxy groups and/or butyleneoxy groups in (Z)ₙ is at least 2.9:1. Also in formula (I), m is on average from about 1.8 to about 5 and n is on average from about 8 to about 25.

The method of forming the dispersing agent comprising the alcohol alkoxylate results in the dispersing agent having minimal VOC content. The method includes the step of providing a branched monohydric alcohol having from about 6 to about 14 carbon atoms. The branched monohydric alcohol is alkoxylated with an alkylene oxide selected from the group of propylene oxide, butylene oxide, and combinations thereof in an amount of from about 1.8 to about 5 moles per mole of branched monohydric alcohol to form an alcohol alkoxylate intermediate. The alcohol alkoxylate intermediate is then alkoxylated with an alkylene oxide selected from the group of ethylene oxide, propylene oxide, butylene oxide, and combinations thereof, in an amount of from about 8 to about 24 moles to form the alcohol alkoxylate. The step of alkoxylating the intermediate is subject to the proviso that the molar ratio of ethylene oxide to propylene oxide and/or butylene oxide with which the intermediate is alkoxylated is at least 2.9:1.

The composition of the instant invention includes a pigment and the dispersing agent of the present invention, and the dispersing agent is capable of attaining color development and freeze/thaw stability similar to that achieved by Triton® CF-10 without any adverse effects on other properties of the composition. Additionally, the dispersing agent of the present invention imparts excellent water sensitivity characteristics to the resultant films formed from the composition and may have substantially no VOCs, thus making the dispersing agent of the present invention a viable alternative to APEOs for use as dispersing agents.

### DETAILED DESCRIPTION OF THE INVENTION

A dispersing agent and a composition including a pigment and the dispersing agent are provided. The composition may be a coating composition including the pigment, the dispersing agent, and a polymeric base, and may be useful in interior and/or exterior architectural coating applications for decorative and/or protective purposes.

The dispersing agent may be used to wet and disperse the pigment in the composition. The dispersing agent may also perform other functions within compositions, such as defoaming and/or wetting of substrates to reduce surface imperfections. The dispersing agents are especially useful in water-based compositions, but may also be useful in solvent-based compositions. Typically, water-based compositions have high surface tension values due to a high surface tension of water. The dispersing agent of the present invention effectively lowers surface tension in the water-based compositions to achieve excellent wetting and even distribution of both pigment and polymer particles throughout a surface and thickness profile of resultant films formed from the coating composition.

The dispersing agent includes a branched alcohol alkoxylate having the following formula (I):

X(Y)ₘ(Z)ₙH (I)

wherein X is a C₆ to C₁₆ branched chain, Y represents a propyleneoxy group, butyleneoxy group, or combination thereof, Z represents an ethyleneoxy group, propyleneoxy group, butyleneoxy group, or combination thereof, m is on average from about 1.8 to about 6, and n is on average from about 8 to about 25. The average values set forth for m and n are more specifically mole averages per molecule of the branched alcohol alkoxylate in the dispersing additive.

Within formula (I), m and n represent an average number of alkyleneoxy groups present in (Y)ₘ and (Z)ₙ, respectively. In this regard, the value of m or n in any particular molecule within the dispersing agent can be lesser or greater than the average values that are set forth above for m and n. Depending upon the value of m in any particular molecule of the branched alcohol alkoxylate in the dispersing agent, (Y)ₘ may represent a single propyleneoxy group or butyleneoxy group, or may represent a polyalkyleneoxy group so long as the average value of m for all molecules of the branched alcohol alkoxylate in the dispersing agent falls within the above-stated range. Typically, at least 90 percent by mole of the branched alcohol alkoxylates present in the dispersing agent have a value for m within the average range set forth above. By indicating above that Y can represent a combination of a propyleneoxy group and a butyleneoxy group, it is meant that within (Y)ₘ, a combination of a propyleneoxy group and a butyleneoxy group may be present. When m is greater than one in any particular molecule, (Y)ₘ represents a polyalkyleneoxy group. Given the fact that m is on average from about 1.8 to 6.0, (Y)ₘ represents a polyalkyleneoxy group in at least some of the individual branched alcohol alkoxylate molecules within the dispersing agent. The polyalkyleneoxy group represented by (Y)ₘ may contain all propyleneoxy groups, all butyleneoxy groups, or a combination of propyleneoxy groups and butyleneoxy groups.

Within formula (I), X is preferably a C₉ to C₁₄ group and m is on average from about 2 to about 5, more preferably from about 3 to about 4. However, the value of m is dependent upon a hydrophobicity of X, with higher hydrophobicity of X typically correlating to lower values of m. Further, Y preferably only represents a propyleneoxy group. Notably, the propyleneoxy groups and/or butyleneoxy groups that are present in (Y)ₘ are more hydrophobic than ethylene oxide. As such, the value of m can be adjusted to render X more hydrophobic, and the combination of X and (Y)ₘ provides a “hydrophobic anchor” to the branched alcohol alkoxylate. Without being limited to any particular theory, it is believed that the combination of X and (Y)ₘ interacts strongly and preferably with either hydrophobic polymeric particles of coating compositions and/or the pigments, thereby promoting preferential surface adsorption on the pigment and/or polymer particles thus promoting their wetting, dispersion and stabilization. This affinity also allows the dispersing agent to provide steric stabilization for the hydrophobic polymeric particles and/or the pigments, which ultimately helps with prevention of agglomeration of the polymeric particles and/or the pigments. Further, the presence of (Y)ₘ, and the adjustment of the value of m within the above ranges, allows the molecular weight of the hydrophobic portion of the surfactant to be increased without increasing hydrophilicity of the branched alcohol alkoxylate. Further still, it is believed that, due to the lower reactivity of the propyleneoxy groups and/or butyleneoxy groups, the presence of (Y)ₘ promotes a higher degree of alkoxylation and complete conversion of residual alcohols and substantial or even complete reduction of volatile organic compound (VOC) content within the dispersing agent. Examples are provided below that show lower VOC content achieved with samples in which X is bonded to a propyleneoxy group, followed by further alkoxylation with ethylene oxide, as compared to samples in which X is directly bonded to ethyleneoxy groups.

Due to the degree of alkoxylation and complete conversion of the residual alcohols while preparing the dispersing agent, a VOC content of less than or equal to 0.5% by weight, more typically less than or equal to 0.2% by weight, most typically less than or equal to about 0.1% by weight, based upon the total weight of the dispersing agent, can be attained per ASTM D 3960. In some instances, the dispersing agent may be free of any measurable VOC content. It is to be appreciated that if m is on average less than 1.8, conversion of the residual alcohol may be hindered, resulting in unacceptably high VOC content of the dispersing agent.

It is also believed that the presence of (Y)ₘ provides flexibility to the branched alcohol alkoxylate, as compared to branched alcohol alkoxylates that include ethyleneoxy groups bonded directly to X, and it is believed that such flexibility promotes excellent freeze/thaw stability of compositions that include the dispersing agent and contributes to resistance to crystallization of the branched alcohol alkoxylate and dispersing agent including the same. Yet another unique benefit of (Y)ₘ is that it provides further enhancement of hydrophobicity of the molecule that imparts excellent water resistance to the resultant films formed from the composition.

As set forth above, Z represents an ethyleneoxy group, propyleneoxy group, butyleneoxy group, or combination thereof, meaning that within (Z)ₙ, a combination of an ethyleneoxy group along with a propyleneoxy group and/or a butyleneoxy group may be present. When n is greater than one in any particular molecule, (Z)ₙ represents a polyalkyleneoxy group. Given the fact that n is on average from about 8 to about 25, (Z)ₙ represents a polyalkyleneoxy group in at least some of the individual branched alcohol alkoxylate molecules within the dispersing agent. Depending upon the value of n in any particular molecule of the branched alcohol alkoxylate in the dispersing agent, (Z)ₙ may represent a single ethyleneoxy group, or may represent, e.g, a polyalkyleneoxy group so long as the average value of n for all molecules of the branched alcohol alkoxylate in the dispersing agent falls within the above-stated range. Typically, at least 90 percent by mole of the branched alcohol alkoxylates present in the dispersing agent have a value for n within the average range set forth above.

Formula (I) is also subject to the proviso that the molar ratio of ethyleneoxy groups to propyleneoxy groups and/or butyleneoxy groups in (Z)ₙ is at least 2.9:1. Preferably, the molar ratio of ethyleneoxy groups to propyleneoxy groups and butyleneoxy groups is at least 3.5:1, alternatively at least 4:1, alternatively 4.6:1. In view of the proviso relative to (Z)ₙ, (Z)ₙ is clearly required to contain ethyleneoxy groups, and may also contain propyleneoxy group(s) and/or butyleneoxy group(s), although propyleneoxy groups and butyleneoxy groups are not required to be present in (Z)ₙ. In this regard, (Z)ₙ may exclusively contain ethyleneoxy groups. The relative amounts of ethyleneoxy groups and other alkyleneoxy groups present in (Z)ₙ is subject to the values set forth in the proviso above. In terms of actual amounts of ethyleneoxy groups, propyleneoxy groups, and butyleneoxy groups present in (Z)ₙ, ethyleneoxy groups are typically present in an average molar amount of from about 8 to about 25 and propyleneoxy and/or butyleneoxy groups may be present in an average molar amount of from greater than 0 to about 6. In one specific embodiment, (Z)ₙ consists of a combination of ethyleneoxy groups and propyleneoxy groups.

In one embodiment, (Z)ₙ consists of ethyleneoxy groups. In any event, in view of the proviso regarding the molar ratio of ethyleneoxy groups to propyleneoxy groups and/or butyleneoxy groups in (Z)ₙ, (Z)ₙ predominantly comprises ethyleneoxy groups. As such, because ethyleneoxy groups are relatively hydrophilic as compared to propyleneoxy groups and butyleneoxy groups, (Z)ₙ effectively provides a hydrophilic extension to the branched alcohol alkoxylate and contributes to the excellent surfactant properties of the branched alcohol alkoxylate by virtue of the strong affinity of (Z)ₙ to the aqueous phase in compositions including the dispersing agent, and further by virtue of the length of (Z)ₙ that protrudes into the composition including the dispersing agent. Regarding length of (Z)ₙ, the value of n is set forth above to be on average from about 8 to about 25. Alternatively, the value of n is on average from about 14 to about 25.

As set forth above, (Z)ₙ may contain propyleneoxy groups and/or butyleneoxy groups, subject to the above-stated proviso. When (Z)ₙ contains propyleneoxy groups and/or butyleneoxy groups, (Z)ₙ may represent a mixed block copolymer of ethyleneoxy groups and propyleneoxy and/or butyleneoxy groups. The presence of propyleneoxy groups and/or butyleneoxy groups in (Z)ₙ does not materially affect affinity of (Z)ₙ with the aqueous phase of the composition due to the fact that ethyleneoxy groups greatly outnumber propyleneoxy groups and/or butyleneoxy groups present therein. Typically evidenced by increased Cloud Point and suppressed Tg or Tc, the presence of the propyleneoxy groups and/or butyleneoxy groups may introduce compositional heterogeneity into (Z)ₙ such that crystallization of the branched alcohol alkoxylate is inhibited, which may otherwise occur when only ethyleneoxy groups are present in (Z)ₙ due to hydrogen bonding between or within molecules of the branched alcohol alkoxylate. Further, it is believed that the presence of the propyleneoxy groups and/or butyleneoxy groups, by virtue of disruption of inter- and intramolecular hydrogen bonds, may further allow for more extensive interactions with the aqueous phase of the composition including the dispersing agent, as compared to when only ethyleneoxy groups are present in (Z)ₙ.

The relative values of X, (Y)ₘ, and (Z)ₙ are preferably set to maximize the beneficial hydrophobic properties of the combination of X and (Y)ₘ as well as the beneficial hydrophilic and crystallization-inhibiting properties of (Z)ₙ. To these ends, in one embodiment, X in formula (I) is a C₉ to C₁₄ group, m is on average from about 2 to about 5, n is on average from about 14 to about 25, and (Z)ₙ consists of ethyleneoxy groups. In one more specific example of a branched alkylene oxide in accordance with this embodiment, X is a C₁₀ group, m is on average from about 3 to about 4, n is on average from about 14 to about 20, and (Z)ₙ consists of ethyleneoxy groups. In another embodiment, X in formula (I) is a C₉ to C₁₄ group, m is on average from about 2 to about 5, n is on average from about 14 to about 25, and (Z)ₙ consists of a combination of ethyleneoxy groups and propyleneoxy groups, with ethyleneoxy groups present in an average molar amount of from about 14 to about 25 and propyleneoxy groups present in an average molar amount of from greater than 0 to about 6 (subject, of course, to the above-stated proviso). In one more specific example of a branched alkylene oxide in accordance with this embodiment, X is a C₁₀ group, m is on average from about 3 to about 4, n is on average from about 14 to about 20, and (Z)ₙ consists of a combination of ethyleneoxy groups and propyleneoxy groups, with ethyleneoxy groups present in an average molar amount of from about 14 to about 17 and propyleneoxy groups present in an average molar amount of from about 3 to about 6.

The method of forming the dispersing agent comprising the alcohol alkoxylate results in the dispersing agent having minimal VOC content. The method includes the step of providing a branched monohydric alcohol having from about 6 to about 14 carbon atoms. Representative branched monohydric alcohols include, but are not limited to, Guerbet alcohols. Such alcohols may be provided as mixtures of primarily branched-chain molecules. One suitable branched monohydric alcohol is 2-propyl heptanol, which typically provides superior wetting and dynamic properties as compared to other alcohols. The branched monohydric alcohol is alkoxylated with an alkylene oxide selected from the group of propylene oxide, butylene oxide, and combinations thereof in an amount of from about 1.8 to about 5 moles per mole of branched monohydric alcohol to form an alcohol alkoxylate intermediate. The alcohol alkoxylate intermediate is then alkoxylated with an alkylene oxide selected from the group of ethylene oxide, propylene oxide, butylene oxide, and combinations thereof, in an amount of from about 8 to about 24 moles. The step of alkoxylating the intermediate is subject to the proviso that the molar ratio of ethylene oxide to propylene oxide and/or butylene oxide with which the intermediate is alkoxylated is at least 4:1. As alluded to above, by first alkoxylating the branched alcohol with the propylene oxide and/or butylene oxide, a higher degree of alkoxylation and complete conversion of residual alcohols and substantial or even complete reduction of volatile organic compound (VOC) content within the dispersing agent can be achieved. The higher degree of alkoxylation is believed to be due to the lower reactivity of the propyleneoxy groups and/or butyleneoxy groups. To explain, by nature of alkoxylation reaction, the resultant dispersing agent is a distribution of branched alcohol alkoxylates of various degrees of alkoxylation centered on a targeted value. As a result, the alkoxylation reaction gives rise to the presence of various branched alcohol alkoxylate oligomers in the dispersing agent, and further gives rise to a molecular weight distribution of the branched alcohol alkoxylates in the dispersing agent. The molecular weight distribution is dictated by the kinetics of the alkoxylation reaction, and the kinetics of the alkoxylation reaction is known to depend on the nature of alkylene oxide and the size of alkylene oxide molecules involved in the alkoxylation reaction. In this regard, ethylene oxide exhibits faster alkoxylation reaction rates than propylene oxide, and propylene oxide exhibits faster alkoxylation reaction rates than butylene oxide. Slower kinetics of alkoxylation, however, allow for more precise control of polymerization and enable narrower molecular weight distributions to be achieved. Thus, a low VOC content within the ranges described above can be achieved by first alkoxylating the branched alcohol with the propylene oxide and/or butylene oxide, which results in narrower molecular weight distributions to be achieved in the dispersing agent as compared to when the branched alcohol is first alkoxylated with ethylene oxide, thereby minimizing the presence of low molecular weight branched alcohol alkoxylates (which may be characterized as VOCs) in the dispersing agent.

It is to be appreciated that more than one type of branched alcohol alkoxylate meeting the above-described parameters may be included in the dispersing agent. The branched alcohol alkoxylate, or combination of branched alcohol alkoxylates, is typically present in the dispersing agent in an amount of up to 100, alternatively from about 70 to about 100, alternatively from about 80 to about 90, percent by weight based on the total weight of the dispersing agent. That is, a total amount of all branched alcohol alkoxylates is typically present in the above-specified amount of from about 80 to about 90 percent by weight based on the total weight of the dispersing agent. More preferably, the branched alcohol alkoxylate, or combination of branched alcohol alkoxylates, is present in the dispersing agent in an amount of about 90 percent by weight based on the total weight of the dispersing agent. The balance of the dispersing agent is typically water. Although additional components may be included in the dispersing agent to improve its miscibility and stabilization, the dispersing agent typically includes only the branched alcohol alkoxylate(s) and water. It is to be appreciated that lower amounts of the branched alcohol alkoxylate may be included in the dispersing agent. However, it is generally more desirable to include as much of the branched alcohol alkoxylate in the dispersing agent as possible, with the ability to do so limited primarily by the ability of the branched alcohol alkoxylate to form thick solutions or solid matter given the propensity of the dispersing agent to crystallize (which is undesirable). Because crystallization may be inhibited by the structure of the branched alcohol alkoxylates described herein, the amount of the branched alcohol alkoxylate present in the dispersing agent may be maximized.

As set forth above, the composition of the present invention includes the dispersing agent and the pigment. A wide range of pigments may be included in the composition. Suitable pigments include inorganic pigments such as titanium dioxide, pigmentary iron oxide (Fe₂O₃) and organic pigments including blue pigments such as Heliogen® blue L 6920, L 6875, and L 6870 from BASF, Monastral® blue FGX from Zeneca, and phthalocyanine blue from Minerva; green pigments such as Monastral® green GNX-C from Zeneca and Heliogen® green L 8735 from BASF; yellow pigments such as Sico® FR 1252 arylide yellow from BASF and Hansa® Bright yellow 2GX70 from Hoechst; red pigments such as Sico® Echtrot L 3855 from BASF, Paliogen® L 4790 quinacridone red from BASF and Novoperm® red 3RK70 from Hoechst; violet pigments such as Paliogen® 5890 dioazine violet from BASF and Monolite® violet RN from Zeneca; orange pigments such as Novoperm® orange HL70 from Hoechst; and similar materials.

In one embodiment, the composition of the present invention is the coating composition. The coating composition, in addition to the pigment and the dispersing agent, includes the polymeric base that may be either solvent-borne or water-borne. For example, the polymeric base is typically a water-based latex component, and the coating composition may be referred to as “latex-based” paint. The latex component is typically in the form of discrete solid polymeric particles formed by the polymerization of at least one ethylenically-unsaturated monomer in an aqueous dispersion medium. The polymeric particles are typically formed by emulsion polymerization in accordance with known technology.

Representative polymeric particles that are suitable for the composition include styrene-acrylic polymers, acrylic polymers, vinyl acetate polymers, vinyl chloride polymers, and combinations thereof. Suitable acrylic polymers include copolymers of acrylonitrile, acrylic acid, methacrylic acid, butylacrylic acid, styrene, and combinations thereof. The polymeric particles typically have a number average particle size of from about 0.05 to about 3 microns, and preferably a number average particle size of about 0.1 to about 0.5 micron. However, it is to be appreciated that solid polymeric particles that are outside of the above ranges may also be suitable for purposes of the present invention.

In addition to the polymeric base, the dispersing agent, and the pigment, the coating composition may further include an additive selected from the group of dispersing agents, defoaming agents, adhesion promoters, viscosity modifiers, additives to improve hiding, additives to improve blocking, neutralizing agents, biocides, fillers, and combinations thereof. It is to be appreciated that the additives set forth above may also be included in the composition of the present invention when the composition is the pigment dispersion.

When the composition of the present invention is the coating composition, the polymeric base is typically present in an amount of from about 30 to about 65 percent by weight, more typically from about 45 to about 55 percent by weight, based on the total weight of the coating composition. The dispersing agent is typically present in an amount of from about 0.1 to about 10 percent by weight, more typically from about 0.1 to about 5.0, most typically from about 0.3 to about 2.0 percent by weight based on the total weight of the coating composition, especially when the polymeric base is water-borne latex. The amount of the dispersing agent included in the composition varies based upon the specific formulation of the coating composition and based upon specific performance requirements. For example, for inorganic pigments, such as titanium dioxide and iron oxide pigment, lesser amounts of the dispersing agent are typically employed as compared to when organic pigments are used. The pigment, typically in the form of pigment concentrate, is used to tint the coating composition and is added in an amount of less than or equal to about 5 percent by weight, more typically from about 0.2 to about 2.0 percent by weight, based on the total weight of the coating composition.

The coating composition typically has a volatile organic compound (VOC) content of less than or equal to about 150 g/L, typically less than or equal to about 50 g/l, which meets or exceeds standards for VOC content in interior and exterior flat and non-flat paints for all sheen ranges. VOCs, as defined herein, are organic chemical compounds that have high enough vapor pressures under normal conditions to significantly vaporize and enter the atmosphere and that are defined as such by the United States Environmental Protection Agency per 40 CFR Part 51.100 (s) and through testing in accordance with ASTM D3960 or EPA Method 24.

The dispersing agent exhibits excellent pigment wetting in compositions that include the pigment and the dispersing agent, which results in excellent color development. Further, compositions including the dispersing agent of the instant invention also exhibit excellent freeze/thaw stability. In particular, the dispersing agent in accordance with the instant invention is capable of attaining color development and freeze/thaw stability similar to that achieved by widely-used APEOs such as Triton® CF-10. Specifically, when the dispersing agent in accordance with the instant invention is used in the coating composition, the coating composition typically exhibits an increase in viscosity of less than or equal to 15 Krebs units (KU), preferably less than or equal to 10 KU, as measured with a Brookfield viscometer at 21° C. with a standard VI-0223 spindle at manufacturer's preset 200 rpm after at least 5 cycles between 18 hours at −18° C. and thawing at least 6 hours to room temperature of about 21° C. Further, when the dispersing agent in accordance with the instant invention is used in the coating composition, the coating composition typically exhibits about 100% pigment tint strength as compared to coating compositions in which Triton® CF-10 is used. Additionally, the dispersing agent of the present invention contains no APEOs, and no aromatic groups in general. Because the dispersing agent may be prepared with a low or no VOC content, the dispersing agent of the present invention is a superior alternative to APEOs for use as dispersing agents.

The following examples are meant to illustrate the present invention and are not to be viewed in any way as limiting to the scope of the present invention.

### EXAMPLES

### Demonstration of the Effect of First Alkoxylating Branched Alcohol with Propylene Oxide on VOC Content of Resulting Branched Alcohol Alkoxylate

The following reference examples are provided to show the differences in VOC content that are obtained when A) a branched alcohol alkoxylate is produced by first alkoxylating a branched alcohol with propylene oxide, followed by ethoxylation, as compared to when B) a branched alcohol alkoxylate is produced by straight ethoxylation of the branched alcohol. In this regard, these reference examples illustrate the significance of chemical structure, and specifically the presence of a propyleneoxy group or groups (or another hydrophobic alkyleneoxy group or groups such as a butyleneoxy group (a)) bonded directly to the branched alcohol for purposes of achieving low VOC content in the resulting branched alcohol alkoxylate after further alkoxylation with ethylene oxide. It is to be appreciated that the branched alcohol alkoxylates presented in these reference examples do not represent branched alcohol alkoxylates of the invention, but are merely provided for proof purposes alone.

Reference examples of the branched alcohol alkoxylates are provided with the features shown in Table 1 below, with measured VOC content also presented in Table 1. VOC content was determined by Method 24, which relies on gravimetric analysis of a small sample (0.3-0.5 g) before and after heating at 110° C. for 60 min. The percentage of mass loss is reported as VOC content, after being corrected for any applicable non-VOC loss. The results of such analysis for various branched alcohol alkoxylates are presented in Table 1.

TABLE 1

| | | Moles of PO | | |
|---|---|---|---|---|
| | | groups bonded | | VOC |
| Reference | | directly to | Moles | Content, |
| Example | Branched Alcohol | Alcohol | EO | % |
| 1 | 2-Propyl Heptanol | 0 | 3 | 36 |
| 2 | 2-Propyl Heptanol | 0 | 4 | 23.85 |
| 3 | 2-Propyl Heptanol | 0 | 5 | 14.62 |
| 4 | 2-Propyl Heptanol | 0 | 8 | 7.07 |
| 5 | 2-Propyl Heptanol | 0 | 9 | 4.34 |
| 6 | 2-Propyl Heptanol | 0 | 10 | 2.57 |
| 7 | 2-Propyl Heptanol | 0 | 14 | 1.08 |
| 8 | 2-Propyl Heptanol | 1 | 4 | 18.77 |
| 9 | 2-Propyl Heptanol | 1 | 5 | 12.01 |
| 10 | 2-Propyl Heptanol | 1 | 6 | 7.58 |
| 11 | 2-Propyl Heptanol | 1 | 7 | 4.42 |
| 12 | 2-Propyl Heptanol | 1 | 8 | 2.75 |
| 13 | 2-Propyl Heptanol | 1 | 9 | 2.9 |
| 14 | 2-Propyl Heptanol | 1 | 10 | 2.04 |
| 15 | 2-Propyl Heptanol | 1 | 14 | 1.16 |

As shown in Table 1, VOC content is prominent in branched alcohol alkoxylates with a lower degree of ethoxylation, but significantly diminished in higher ethoxylated products as their overall MW shifts towards high boiling point and away from low boiling point materials. As also shown in Table 1, branched alcohol alkoxylates that have 1 mole of propyleneoxy groups bonded directly to the branched alcohol have lower VOC content than branched alcohol alkoxylates that have ethyleneoxy groups bonded directly to the branched alcohol (with the comparison made between branched alcohol alkoxylates having the same number of moles of ethyleneoxy groups present therein). In particular, the branched alcohol alkoxylates that have 1 mole of propyleneoxy groups bonded directly to the branched alcohol exhibit slightly but consistently lower VOC content as compared to similar branched alcohol alkoxylates that have ethyleneoxy groups bonded directly to the branched alcohol.

Demonstration of Reaction Kinetics on the Molecular Weight Distribution within Branched Alcohol Alkoxylates

As alluded to above, VOC content is determined by the content of lower molecular weight branched alcohol alkoxylates present after the alkoxylation reaction. The content of lower molecular weight branched alcohol alkoxylates is controlled by the kinetics of the alkoxylation reaction, and the kinetics of the alkoxylation reaction depend on the nature and size of the alkylene oxide with ethylene oxide exhibiting the fastest alkoxylation reaction rates, followed by propylene oxide, which is followed by butylene oxide with even slower alkoxylation reaction rates.

Slower kinetics of alkoxylation allow for better control of polymerization and slightly narrower molecular weight distribution. To demonstrate this point, highly ethoxylated branched alcohol alkoxylates and highly propoxylated branched alcohol alkoxylates of the following chemical structures are compared:

1) 2-Propyl Heptanol ethoxylated with 8 moles of ethylene oxide, represented as:

2-PH-(EO)₈;

2) 2-Propyl Heptanol propoxylated with 1 mole of propylene oxide followed by ethoxylation with 8 moles of ethylene oxide, represented as:

2-PH—PO-(EO)₈

3) 2-Propyl Heptanol ethoxylated with 0.5 moles of ethylene oxide followed by propoxylation with 10 moles of propylene oxide, represented as:

2PH-(EO)_{0.5}-(PO)₁₀

GC/MS spectra for the branched alcohol alkoxylates 1)-3) show that all spectra comprise of multiple peaks spread over a range of molecular weight, which supports the fact that the branched alcohol alkoxylates 1)-3) appear to comprise mixtures of various oligimers. However, the character of the distribution differs greatly between branched alcohol alkoxylates 1) and 2) and branched alcohol alkoxylate 3). Thus, judging by equal intensity of the peaks, highly ethoxylated branched alcohol alkoxylates (e.g., branched alcohol alkoxylates 1) and 2)) exhibit a distribution of oligomeric products that are evenly presented in the mixture. On the other hand, highly propoxylated branched alcohol alkoxylates (e.g., branched alcohol alkoxylates 3)) shows typical statistical distribution of peak intensities centered on the targeted value, suggesting that the molecular weight distribution is much narrower. VOC content, determined by the content of lower molecular weight compounds present in the branched alcohol alkoxylates, is significantly lower for branched alcohol alkoxylate 3) as compared to branched alcohol alkoxylates 1) and 2). This analysis shows that slower alkoxylation reaction kinetics of propylene oxide allow for better polymerization control and narrower molecular weight distribution of the resultant branched alcohol alkoxylates, thereby resulting in lower VOC content of branched alcohol alkoxylates as the amount of propyleneoxy groups in the branched alcohol alkoxylates increases.

### Demonstration of the Effect of 1 Mole of Propylene Oxide on Molecular Weight Distribution and VOC Content of Branched Alcohol Alkoxylates

To demonstrate that the presence of as little as 1 mole of propylene oxide in the branched alcohol alkoxylates will provide a measurable effect on the molecular weight distribution and VOC content of the branched alcohol alkoxylates, four branched alcohol alkoxylates were selected for GC analysis of molecular weight distribution:

1) 2-Propyl Heptanol ethoxylated with 8 moles of ethylene oxide, represented as:

2PH-(EO)₈

2) 2-Propyl Heptanol propoxylated with 1 mole of propylene oxide followed by ethoxylation with 8 moles of ethylene oxide, represented as:

2PH—PO-(EO)₈

3) 2-Propyl Heptanol ethoxylated with 14 moles of ethylene oxide, represented as:

2PH-(EO)₁₄

4) 2-Propyl Heptanol propoxylated with 1 mole of propylene oxide followed by ethoxylation with 14 moles of ethylene oxide, represented as:

2PH—PO-(EO)₁₄

As shown in Table 1 above, based on Method 24 analysis, branched alcohol alkoxylates 2) and 4) have consistently lower VOC content than branched alcohol alkoxylates 1) and 3). GC analysis of branched alcohol alkoxylates 1)-4) indicate that significant differences exist in terms of the amounts of product in the lowest molecular weight range between branched alcohol alkoxylates 1) and 3) and branched alcohol alkoxylates 2) and 4), with the area under the lowest molecular weight range peak 4 times higher for branched alcohol alkoxylates 1) and 3) compared to branched alcohol alkoxylates 2) and 4). This could be a main contributing factor to higher VOC values of Reference Examples 1-7 versus Reference Examples 8-15 in Table 1. Thus, these results indicate that alkoxylating with a small amount of propylene oxide during the alkoxylation reaction can control kinetics of polymerization and yield narrower molecular weight distribution and, hence, produce branched alcohol alkoxylates with lower VOC content.

### Preparation of Coating Compositions Formulated Using Different Dispersing Agents

Various examples of coating compositions are formulated using different dispersing agents. The coating composition is formulated by first preparing the dispersing agents. To prepare the dispersing agents, the branched alcohol alkoxylate is provided alone (for purposes of Dispersing Agent A), or is mixed with water, the water being present in an amount of up to 20 percent by weight, typically from 10 to 20 percent by weight based upon the total weight of the combined branched alcohol alkoxylate and water (for purposes of Dispersing Agent B). The order of addition is unimportant, but typically water is added to the branched alcohol alkoxylate after premelting the branched alcohol alkoxylate at a temperature of from 60 to 80° C. The dispersing agents employed in the instant Examples, as well as comparative dispersing agents, are as follows:

Dispersing Agent A is 100 percent by weight of an alkylene oxide adduct of a branched C-10 alcohol, with 3 to 4 moles of propylene oxide reacted with the branched C-10 alcohol followed by 12 to 16 moles of ethylene oxide.

Dispersing Agent B is 90 percent by weight of Dispersing Agent A and 10 percent by weight of water, based on the total weight of Dispersing Agent B.

Comparative Dispersing Agent A is Triton® CF-10 commercially available from Dow Chemical of Midland, Mich.

Coating compositions are prepared including the Dispersing Agents A and B of the present invention, and comparative compositions are prepared including the Comparative Dispersing Agent A. The compositions are formulated with an equal active weight replacement of the comparative dispersing agents with dispersing agents of the present invention based upon activity of the comparative dispersing agent to be compared. For example, if the dispersing agent of the present invention is compared to a comparative dispersing agent that is 90% active, and the charge for the comparative dispersing agent is 10 grams, the Dispersing Agent A of the present invention would be charged at 9 grams because this dispersing agent is 100% active, whereas the Dispersing Agent B of the present invention would be charged at 10 grams because this dispersing agent is 90% active.

Components to be included in the coating composition are set forth in Table 2. The coating composition is prepared by introducing the respective dispersing agents into the polymeric bases set forth in Table 2 in the amounts set forth in Table 2 and thoroughly shaking the coating composition to mix the components. The coating compositions were then allowed to equilibrate, defoam, and properly disperse prior to testing. In Table 2, an “X” in the rows corresponding to the polymeric bases indicates the presence of the polymeric base in the coating composition, while a “-” indicates the absence of the polymeric base in the coating composition. Amounts of the dispersing agent present in the coating compositions are presented in pounds of active content per 100 gallons (lbs/100 gal.) of the coating composition. For example, a 90% active dispersing agent present in an amount of 5 lbs/100 gal. would be listed in Table 2 as present in an amount of 4.5 lbs/100 gal.

TABLE 2

| Component | Ex. 1 | Ex. 2 | Ex. 3 | Ex. 4 | Ex. 5 | Ex. 6 | Ex. 7 |
|---|---|---|---|---|---|---|---|
| Dispersing Agent A | 3.5 | 4.4 | 4.5 | 5.0 | 5.5 | — | 5.0 |
| Dispersing Agent B | — | — | — | — | — | 5.0 | — |
| Comparative | — | — | — | — | — | — | — |
| Dispersing AgentA | | | | | | | |
| Polymeric Base A | X | X | X | X | X | — | — |
| Polymeric Base B | — | — | — | — | — | X | X |
| | Comp. | Comp. | Comp. | Comp. | Comp. | Comp. | Comp. |
| Component | Ex. 1 | Ex. 2 | Ex. 3 | Ex. 4 | Ex. 5 | Ex. 6 | Ex. 7 |
| Dispersing Agent A | — | — | — | — | — | — | — |
| Dispersing Agent B | — | — | — | — | — | | — |
| Comparative | 3.5 | 4.4 | 4.5 | 5.0 | 5.5 | 5.0 | — |
| Dispersing AgentA | | | | | | | |
| Polymeric Base A | X | X | X | X | X | — | — |
| Polymeric Base B | — | — | — | — | — | X | X |

Polymeric Base A contains Rhoplex® SG 10, Rhoplex® VSR 1050 or a similar resin.

Polymeric Base B contains Primal® SG 380, Rhoplex® SG 30 or a similar resin.

Physical properties of the coating compositions are tested and compared to illustrate the effectiveness of the dispersing agents of the present invention. Physical properties of the coating composition that are tested include freeze/thaw stability, DE* value (color change), tint strength, scrub resistance, paint heat stability, and water resistance.

Freeze/thaw stability is measured with a Brookfield viscometer at 21° C. with a VI-0223 spindle at 200 rpm after exposing the coating composition to temperature cycling. In particular, the coating composition is subjected to temperature cycles in which the coating composition is cooled for 18 hours at −18° C., followed by thawing for a period of at least 6 hours, typically from 6-7 hours, to room temperature of about 21° C. A cycle is represented by one period of cooling and one period of thawing. Viscosity is measured after each cycle to determine the change in viscosity of the coating composition from an initial viscosity.

DE* value defines a total color difference, as measured on the CIELAB color scale using a spectrophotometer, between a film formed from a tested coating composition and a film formed from a standard coating composition. The lower the DE* number, the closer the color is to the control. Two different standard coating compositions are used to determine DE* values. A first standard coating composition, for purposes of obtaining “DE* Value 1” in Table 4 below, is the comparative coating composition including amounts of Triton CF-10 corresponding to the amounts of the dispersing agent for the tested coating composition. For example, Example 4 contains 5 lbs of dispersing agent per 100 gal. of polymeric base, and is compared to Comparative Example 4, which contains 5 lbs. of Triton® CF-10 per 100 gal. of polymeric base for purposes of determining DE* Value 1. A second standard coating composition, for purposes of obtaining “DE* Value 2 in Table 4 below, is the comparative coating composition including 3.5 lbs. of Triton CF-10 per 100 gal. of polymeric base (e.g., Comparative Example 1).

Tint strength is a measurement of developed color of film formed from a coating composition and is obtained through a computer program that calculates a percentage difference of a tested coating composition as compared to a standard coating composition based upon readings from the spectrophotometer. A developed color of a film formed from a standard coating composition is set at 100%, and all films formed from tested coating compositions are compared to the standard coating composition. A film with a tint strength that is higher than 100% is darker and has more developed color than the film formed from the standard coating composition. A film with a tint strength of less than 100% is lighter in developed color than the film formed from the standard coating composition and has less developed color than the film formed from the standard coating composition. As with DE* values, two different standard coating compositions are used to determine tint strength. For “Tint Strength 1” in Table 4, Examples are compared to respective Comparative Examples in the same manner that DE* is determined for “DE* Value 1”. Likewise, for “Tint Strength 2” in Table 4, Examples are compared to Comparative Example 1 containing 3.5 lbs. of Triton® CF-10 per 100 gal. of polymeric base.

To measure DE* values and tint strength in the instant Examples, universal organic red pigment is added to the coating compositions in an amount of about 1.2 percent by weight based on the total weight of the coating compositions. The pigment is dispersed by shaking the coating composition including the pigment for about 3 minutes using a Lau disperser. The coating composition is then left overnight to defoam. The coating compositions are then drawn down on Leneta sheets. Samples are then air dried or oven dried, after which DE* values are measured with an X-Rite machine.

Scrub resistance is measured for the cured films cast on P 121-10N Leneta panels by measuring the number of scrubs necessary to achieve a 10% film loss using a Gardco® Washability and Wear Tester equipped with Gardco® scrub brush WA-2272 and using shim and scrub media SC-2. Paint heat stability is determined as a measure of difference between initial viscosity of the coating compositions and viscosity after heating the coating compositions for 14 days at 50° C. Water resistance is measured by casting 20-25 mil thickness coating on a Teflon board, curing for 7 days and submerging a 1 in² sample of the cured films in water for 24 hours and measuring a difference between initial weight of the cured films and the post-submerging weight.

Freeze/thaw stabilities for the various Examples are set forth below in Table 3, indicated as a measure of viscosity in Krebs units of the coating composition with measurement performed with a Brookfield viscometer at 21° C. with a VI-0223 spindle at 200 rpm after each cycle.

TABLE 3

| Example | Initial | Cycle 1 | Cycle 2 | Cycle 3 | Cycle 4 | Cycle 5 |
|---|---|---|---|---|---|---|
| Ex. 1 | N/A | N/A | N/A | N/A | N/A | N/A |
| Ex. 2 | N/A | N/A | N/A | N/A | N/A | N/A |
| Ex. 3 | 96.2 | 103.7 | 106.3 | 106.7 | 106.1 | 105.8 |
| Ex. 4 | 94.8 | 100.5 | 105.4 | 106.2 | 106.4 | 104.8 |
| Ex. 5 | 92.1 | 99.6 | 102.8 | 103.4 | 103.7 | 102.6 |
| Ex. 6 | 107.6 | 113.2 | 113.4 | 120.6 | 125.2 | 122.3 |
| Ex. 7 | N/A | N/A | N/A | N/A | N/A | N/A |
| Comp. Ex. 1 | N/A | N/A | N/A | N/A | N/A | N/A |
| Comp. Ex. 2 | N/A | N/A | N/A | N/A | N/A | N/A |
| Comp. Ex. 3 | 102.6 | 104.9 | 106.4 | 106.8 | 106.2 | 106.9 |
| Comp. Ex. 4 | 101.2 | 103.4 | 104.1 | 104.7 | 104.3 | 104.5 |
| Comp. Ex. 5 | 98.7 | 101.2 | 101.5 | 102.0 | 102.2 | 102.6 |
| Comp. Ex. 6 | 108.9 | 115.8 | 117.4 | 121.6 | 124.3 | 123.7 |
| Comp. Ex. 7 | 117.2 | Solid | — | — | — | — |

The DE* values and tint strength of films formed using the coating compositions are provided in Table 4 below.

TABLE 4

| | | DE* | | DE* | | | | |
|---|---|---|---|---|---|---|---|---|
| | DE* | Value | DE* | Value | Tint | Tint | Tint | Tint |
| | Value | 1, | Value | 2, | Strength | Strength | Strength | Strength |
| | 1, Air | Oven | 2, Air | Oven | 1, Air | 1, Oven | 2, Air | 2, Oven |
| Example | Dried | Dried | Dried | Dried | Dried, % | Dried, % | Dried, % | Dried, % |
| Ex. 1 | 0.06 | 0.12 | 0.06 | 0.23 | 100.3 | 99.2 | 100.3 | 100.3 |
| Ex. 2 | 0.04 | 0.10 | 0.13 | 0.09 | 100.2 | 100.0 | 101.1 | 100.7 |
| Ex. 3 | N/A | N/A | N/A | N/A | N/A | N/A | N/A | N/A |
| Ex. 4 | 0.07 | 0.07 | 0.18 | 0.18 | 100.3 | 100.4 | 101.5 | 101.2 |
| Ex. 5 | N/A | N/A | N/A | N/A | N/A | N/A | N/A | N/A |
| Ex. 6 | N/A | N/A | N/A | N/A | N/A | N/A | N/A | N/A |
| Ex. 7 | 0.09 | N/A | N/A | N/A | 99.3 | N/A | N/A | N/A |

Other physical properties of the coating compositions or films formed therefrom are provided below in Table 5.

TABLE 5

| | Scrub | | Heat Stability, | Water |
|---|---|---|---|---|
| | Resistance, | Heat Stability, | After 14 Days | Resistance, |
| Example | cycles | Initial, KU | at 50° C., KU | mg |
| Ex. 4 | 2000 | 92.7 | 97.6 | 7.66 |
| Ex. 7 | >2000 | 107.6 | 112.2 | |
| Comp. | 2000 | 97.2 | 100.7 | 9.67 |
| Ex. 4 | | | | |
| Comp. | >2000 | 108.9 | 111.5 | |
| Ex. 6 | | | | |

Obviously, many modifications and variations of the present invention are possible in light of the above teachings, and the invention may be practiced otherwise than as specifically described within the scope of the appended claims. It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

What is claimed is:

1. A dispersing agent comprising a branched alcohol alkoxylate having the following formula (I):
X(Y)ₘ(Z)ₙH (I)
wherein
X is a C₆ to C₁₆ branched chain;
Y represents a propyleneoxy group, butyleneoxy group, or combination thereof;
Z represents an ethyleneoxy group, propyleneoxy group, butyleneoxy group, or combination thereof, with the proviso that the molar ratio of ethyleneoxy groups to propyleneoxy groups and/or butyleneoxy groups in (Z)ₙ is at least 2.9:1;
m is on average from about 1.8 to about 5; and
n is on average from about 8 to about 25.

2. A dispersing agent as set forth in claim 1 wherein X is a C₉ to C₁₄ group.

3. A dispersing agent as set forth in claim 1 wherein m is on average from about 3 to about 4.

4. A dispersing agent as set forth in claim 3 wherein n is on average from about 14 to about 25.

5. A dispersing agent as set forth in claim 1 wherein (Z)ₙ consists of ethyleneoxy groups.

6. A dispersing agent as set forth in claim 1 wherein (Z)ₙ consists of a combination of ethyleneoxy groups and propyleneoxy groups, with ethyleneoxy groups present in an average molar amount of from about 14 to about 25 and propyleneoxy groups present in an average molar amount of from greater than 0 to about 6.

7. A dispersing agent as set forth in claim 1 wherein X is a C₉ to C₁₄ group, m is on average from about 2 to about 5, n is on average from about 14 to about 25, and (Z)ₙ consists of ethyleneoxy groups.

8. A dispersing agent as set forth in claim 7 wherein X is a C₁₀ group, m is on average from about 3 to about 4, n is on average from about 14 to about 20, and (Z)ₙ consists of ethyleneoxy groups.

9. A dispersing agent as set forth in claim 1 wherein X is a C₉ to C₁₄ group, m is on average from about 2 to about 5, n is on average from about 14 to about 25, and (Z)ₙ consists of a combination of ethyleneoxy groups and propyleneoxy groups, with ethyleneoxy groups present in an average molar amount of from about 14 to about 25 and propyleneoxy groups present in an average molar amount of from greater than 0 to about 6.

10. A dispersing agent as set forth in claim 1 wherein said branched alcohol alkoxylate is present in an amount of from about 80 to about 90 percent by weight based upon the total weight of said wetting additive.

11. A dispersing agent as set forth in claim 1 having a volatile organic compound content of less than or equal to 0.5% by weight based upon the total weight of the dispersing agent.

12. A composition comprising:
(a) a pigment; and
(b) a dispersing agent comprising a branched alcohol alkoxylate having the following formula (I):
X(Y)ₘ(Z)ₙH (I)
wherein
X is a C₆ to C₁₆ branched chain;
Y represents a propyleneoxy group, butyleneoxy group, or combination thereof;
Z represents an ethyleneoxy group, propyleneoxy group, butyleneoxy group, or combination thereof, with the proviso that the molar ratio of ethyleneoxy groups to propyleneoxy groups and/or butyleneoxy groups in (Z)ₙ is at least 2.9:1;
m is on average from about 1.8 to about 5; and
n is from about 8 to about 25.

13. A composition as set forth in claim 12 wherein X is a C₉ to C₁₄ group.

14. A composition as set forth in claim 12 wherein m is on average from about 3 to about 4.

15. A composition as set forth in claim 12 wherein n is on average from about 14 to about 25.

16. A composition as set forth in claim 12 wherein (Z)ₙ consists of ethyleneoxy groups.

17. A composition as set forth in claim 12 wherein (Z)ₙ consists of a combination of ethyleneoxy groups and propyleneoxy groups, with ethyleneoxy groups present in an average molar amount of from about 14 to about 25 and propyleneoxy groups present in an average molar amount of from greater than 0 to about 6.

18. A composition as set forth in claim 12 further defined as a coating composition.

19. A composition as set forth in claim 18 further comprising a polymeric base.

20. A composition as set forth in claim 19 wherein said polymeric base is present in an amount of from about 30 to about 65 percent by weight based on the total weight of said composition.

21. A composition as set forth in claim 20 wherein said dispersing agent is present in an amount of from about 0.1 to about 10 percent by weight based on the total weight of said composition.

22. A composition as set forth in claim 21 wherein said pigment is present in an amount of less than or equal to about 5 percent by weight based on the total weight of said composition.

23. A composition as set forth in claim 20 having volatile organic components present in an amount of less than about 50 g/l.

24. A composition as set forth in claim 12 that exhibits an increase in viscosity of less than or equal to 15 KU after at least 5 cycles between 18 hours at −18° C. and thawing at least 6 hours to room temperature of about 21° C.

25. A method of forming a dispersing agent comprising an alcohol alkoxylate with the dispersing agent having minimal VOC content, said method comprising the steps of:
providing a branched monohydric alcohol having from about 6 to about 14 carbon atoms;
alkoxylating the branched monohydric alcohol with an alkylene oxide selected from the group of propylene oxide, butylene oxide, and combinations thereof in an amount of from about 1.8 to about 5 moles per mole of branched monohydric alcohol to form an alcohol alkoxylate intermediate; and
alkoxylating the alcohol alkoxylate intermediate with an alkylene oxide selected from the group of ethylene oxide, propylene oxide, butylene oxide, and combinations thereof, in an amount of from about 8 to about 24 moles, with the proviso that the molar ratio of ethylene oxide to propylene oxide and/or butylene oxide is at least 2.9:1, to form the alcohol alkoxylate.
